(19) United States
(12) Patent Application Publication
(10) Pub. No.: US 2025/0063147 A1
(43) Pub. Date: Feb. 20, 2025

(54) DRIVE VIDEO RECORD SYSTEM FOR VEHICLE AND METHOD FOR CONTROLLING THE SAME

(71) Applicants: Hyundai Motor Company, Seoul (KR); Kia Corporation, Seoul (KR)

(72) Inventors: Ho Tae Park, Hwaseong (KR); Hyun Sang Kim, Hwaseong (KR); Yun Sup Ann, Hwaseong (KR)

(21) Appl. No.: 18/746,702

(22) Filed: Jun. 18, 2024

(30) Foreign Application Priority Data
Aug. 14, 2023 (KR) 10-2023-0106218

(51) Int. Cl. H04N 7/18; H04N 5/91; H04N 23/62

(52) U.S. Cl. CPC H04N 7/188; H04N 5/91; H04N 23/62

(57) ABSTRACT

A drive video record system includes a camera module configured to monitor surroundings of a vehicle, a first memory that stores a video transmitted from the camera module, and a controller having a second memory that stores a computer program for controlling storage of the video and a processor that executes the computer program. A control method of the drive video record system includes receiving, by the processor executing the computer program, information related to a speed bump; and executing, by the controller, an impact desensitization logic based on the information.

### CROSS-REFERENCE TO RELATED APPLICATION

The present application claims under 35 U.S.C. § 119 (a) the benefit of Korean Patent Application No. 10-2023-0106218, filed on Aug. 14, 2023, the entire contents of which are incorporated herein by reference.

### BACKGROUND

### (a) Technical Field

The present disclosure relates to a drive video record system for a vehicle and a control method of a drive video recording device.

### (b) Description of the Related Art

A drive video record system, for example, is a device for recording videos of a driving situation of a vehicle.

The drive video record system may include a controller, a memory for storing videos, and a camera for recording the videos.

In general, the drive video record system stores corresponding driving data together with surrounding video, and also records videos according to a previously-input setting when a set event is sensed to occur, for example, when the vehicle is parked.

The drive video record system, or a so-called black box, for a vehicle was initially installed as an external device through the after-market, but recently, it has been installed as a built-in type.

A storage mode of the drive video record system generally includes a constant (recording) mode and an event (recording) mode.

The drive video record system stores videos constantly in the constant mode and stores videos of only a duration before and after an event occurs in the event mode.

In the event mode, an impact detection sensor is used to determine the occurrence of an event, and in this case, even an impact caused by a speed bump or a pothole is sensed as an event and the scene is recorded as an event recording which results in excessive event recording storage files.

It would be desirable to provide an improved drive video record system that avoided excessive recordings of unnecessary events, which results in increased time and complexity for users to find necessary recording videos and may hinder efficient use of a secure digital (SD) card.

### BRIEF SUMMARY

An embodiment of the present disclosure provides a drive video record system capable of efficiently recording an event in consideration of the presence of a speed bump or a pothole, for example, and a control method thereof.

According to an embodiment of the present disclosure, a control method of a drive video record system, which comprises a camera module configured to monitor surroundings of a vehicle, a first memory configured to store a video transmitted from the camera module, and a controller comprising a second memory configured to store a computer program for controlling storage of the video and a processor configured to execute the computer program, includes receiving, by the processor executing the computer program, information related to a speed bump; and executing an impact desensitization logic based on the information.

In at least one embodiment of the present disclosure, the executing the impact desensitization logic includes receiving a selection for executing the impact desensitization logic from a user.

In at least one embodiment of the present disclosure, the receiving the selection includes popping up a window through which the selection is input on an audio video navigation telematics (AVNT) screen according to the information, and wherein the executing the impact desensitization logic includes notifying through the AVNT screen that the impact desensitization logic will be executed.

In at least one embodiment of the present disclosure, the executing the impact desensitization logic includes determining whether to execute the impact desensitization logic according to object recognition information received from a sensor or a controller of an advanced driving assistance system (ADAS).

In at least one embodiment of the present disclosure, the executing the impact desensitization logic includes at least one of determining a time of initiating the impact desensitization logic or determining whether a transmission gear position is at a “D (Drive)” position.

In at least one embodiment of the present disclosure, the determining the time includes adjusting the time according to a brake operation.

In at least one embodiment of the present disclosure, the executing the impact desensitization logic includes adjusting a setting for an event-based recording.

In at least one embodiment of the disclosure, the adjusting the setting for the event-based recording includes at least one of deactivating the event-based recording or adjusting an impact sensitivity level of the event-based recording.

In at least one embodiment of the present disclosure, the receiving the information includes receiving information related to a plurality of successive speed bumps, and the executing the impact desensitization logic includes executing the impact desensitization logic sequentially and repeatedly for the plurality of speed bumps.

In at least one embodiment of the present disclosure, the receiving the information includes receiving the information from the AVNT or a preview electrically controlled suspension (Preview-ECS).

According to an embodiment of the present disclosure, a drive video record system for a vehicle comprises a camera module configured to monitor surroundings of the vehicle, a first memory configured to store a video transmitted from the camera module, and a controller comprising a second memory configured to store a computer program for controlling storage of the video, and a processor configured to execute the computer program, wherein the controller is configured to receive information related speed bump and executes an impact desensitization logic based on the information by the processor executing the computer program.

In the drive video record system according to at least one embodiment of the present disclosure, the controller is further configured to receive a selection for executing the impact desensitization logic from a user.

In the drive video record system according to at least one embodiment of the present disclosure, the controller is further configured to pop up a window through which the selection is input on an audio video navigation telematics (AVNT) screen according to the information and notify through the AVNT screen that the impact desensitization logic will be executed.

In the drive video record system according to at least one embodiment of the present disclosure, the controller is further configured to determine whether to execute the impact desensitization logic according to object recognition information received from a sensor or a controller of an advanced driving assistance system (ADAS).

In the drive video record system according to at least one embodiment of the present disclosure, the controller is further configured to perform at least one of determining a time of initiating the impact desensitization logic or determining whether a transmission gear position is positioned at a “D (Drive)” position.

In the drive video record system according to at least one embodiment of the present disclosure, the controller is further configured to adjust the time according to a brake operation.

In the drive video record system according to at least one embodiment of the present disclosure, the controller is further configured to adjust a setting for an event-based recording.

In the drive video record system according to at least one embodiment of the present disclosure, the controller is further configured to perform at least one of deactivating an event-based recording and adjusting an impact sensitivity level of the event-based recording.

In the drive video record system according to at least one embodiment of the present disclosure, the controller is further configured to receive information related to a plurality of successive speed bumps, and wherein the controller is further configured to execute the impact desensitization logic sequentially and repeatedly for the plurality of speed bumps.

In the drive video record system according to at least one embodiment of the present disclosure, the controller is further configured to receive the information from the AVNT or a preview electrically controlled suspension (Preview-ECS).

A vehicle may include the drive video record system.

According to an embodiment of the present disclosure, since the event recording is performed in consideration of the existence of the speed bump or the pothole in advance, the time and complexity required to find a recording video required in the related art can be reduced or alleviated.

In addition, according to an embodiment of the present disclosure, since unnecessary recordings of videos are prevented, efficient use of an SD card may also be achieved.

### BRIEF DESCRIPTION OF DRAWINGS

FIG. 1 is a block diagram conceptually showing elements of a drive video record system according to an embodiment of the present disclosure.

FIG. 2 is a flowchart illustrating a control process according to an embodiment of the present disclosure.

FIGS. 3 and 4 illustrate audio video navigation telematics (AVNT) screens according to an embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Since the present disclosure is modified in various ways and has various embodiments, specific embodiments will be illustrated and described in the drawings. However, this is not intended to limit the present disclosure to specific embodiments, and it should be understood that the present disclosure includes all modifications, equivalents, and replacements included on the idea and technical scope of the present disclosure.

Terms including ordinals such as “first,” “second,” and the like may be used to describe various elements, but the elements are not limited by the terms. The terms are used only for the purpose of distinguishing one element from another element.

When an element is “connected” or “linked” to another element, it should be understood that the element may be directly connected or connected to another element, but another element may exist in between.

Unless otherwise defined, all terms used herein, including technical or scientific terms, have the same meaning as that generally understood by those skilled in the art. It will be understood that terms, such as those defined in commonly used dictionaries, should be interpreted as having a meaning that is consistent with their meaning in the context of the relevant art and will not be interpreted in an idealized or overly formal sense unless expressly so defined herein.

In addition, the term “unit” or “control unit” is a term widely used for naming a controller that commands a specific function, and does not mean a generic function unit. For example, each unit or control unit may include a communication device communicating with another controller or sensor, a computer-readable recording medium storing an operating system or a logic command, input/output information, and the like, in order to control a function in charge, and one or more processors performing determination, calculation, determination, and the like necessary for controlling a function in charge.

Meanwhile, the processor includes a semiconductor integrated circuit and/or electronic devices that perform at least one or more of comparison, determination, calculation, and determination in order to achieve a programmed function. For example, the processor may be a computer, a microprocessor, a CPU, an ASIC, and a circuitry (logic circuits), or a combination thereof.

In addition, the computer-readable recording medium (or simply referred to as a memory) includes all types of storage devices in which data that can be read by a computer system is stored. For example, the memory may include at least one type of a flash memory of a hard disk, of a microchip, of a card (e.g., a secure digital (SD) card or an eXtream digital (XD) card), etc., and at least a memory type of a Random Access Memory (RAM), of a Static RAM (SRAM), of a Read-Only Memory (ROM), of a Programmable ROM (PROM), of an Electrically Erasable PROM (EEPROM), of a Magnetic RAM (MRAM), of a magnetic disk, and of an optical disk.

The recording medium is electrically connected to the processor, and the processor retrieves and records data from the recording medium. The recording medium and the processor either may be integrated or may be physically separated.

Hereinafter, the embodiments of the present disclosure will be described in detail with reference to the accompanying drawings.

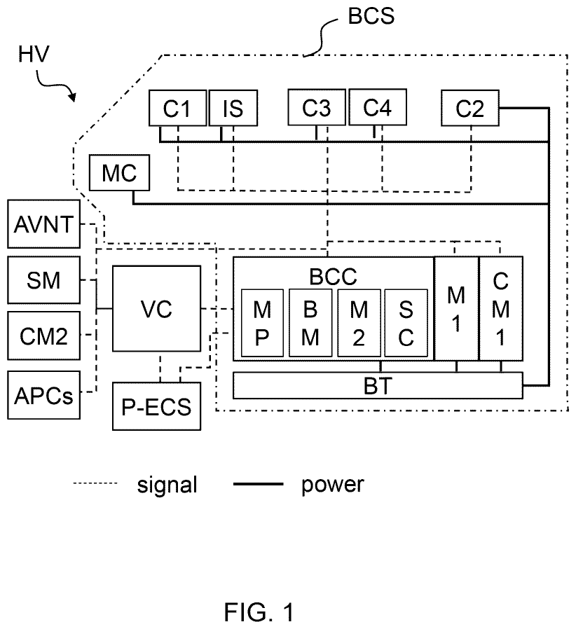

Referring to FIG. 1, a built-in camera system BCS, which is an embedded drive video record system according to an embodiment of the present disclosure, is installed in a host vehicle HV, and includes a camera module C, a computer-readable storage medium M1, a first communication module CM1, a microphone MC, an impact sensor IS, a power-assisted battery BT, and a built-in camera controller BCC.

Although the video record system of the present embodiment is a built-in type, it is not limited thereto.

First, the camera module C includes a front camera and a rear camera in this embodiment, but it is not necessarily limited thereto. The front camera is installed to capture an image of the front area of the vehicle HV and to capture an image of the rear area of the vehicle HV

For example, the front camera may be installed at a position near the room mirror in the vehicle (HV) cabin of the window shield, and the rear camera may be installed at the rear window of the vehicle (HV) cabin or the rear bumper.

For example, the front camera and the rear camera have the image quality of either an HD, an FHD, or a Quad HD.

It is evident that the front camera and the rear camera do not need to have the same image quality, and a camera of an Advanced Drive Assistance System ADAS system of the host vehicle HV may be used.

Further, the camera has an aperture value of F2.0 or less, preferably F1.6 or less. If the aperture value decreases, more light is gathered so that recording may be made brighter. In addition, by applying image tuning technology to minimize the noise and the loss of light, clear recording is possible even in a dark environment.

The computer-readable recording medium (hereinafter, called “memory”, in short) includes all types of storage devices in which data that can be read by a computer system is stored. For example, the memory includes at least a memory type of a flash memory, of a hard disk, of a microchip, of a card (e.g., a Secure Digital (SD) card or an eXtream Digital (XD) card), etc., and at least a memory type of a Random Access Memory (RAM), of a Static RAM (SRAM), of a Read-Only Memory (ROM), of a Programmable ROM (PROM), of an Electrically Erasable PROM (EEPROM), of a Magnetic RAM (MRAM), of a magnetic disk, and of an optical disk.

In this embodiment, the memory M1 is 64 GB (gigabytes) or more, e.g., on an SD card such as a Micro SD card, and is preferably of an external type. For example, event recording according to impact detection may be performed up to several tens of times. The event recording may include recording according to impact generation during traveling (hereinafter, referred to as “main row impact recording”) and recording according to impact generation during parking (hereinafter, referred to as “parking impact recording”). Here, whether the current mode is the driving mode or the parking mode may be determined to be the driving mode when the vehicle start switch is in an “IGN ON” (ignition on) state, and may be determined to be the parking mode when the vehicle start switch is not in the “ON” state.

The user can easily check the contents stored in the memory in a desktop computer or the like by extracting the SD card.

The information of the state of the SD card can be checked through the connected car service, and the time of replacement according to the memory state can also be checked.

The first communication module CM1 is for wired or wireless communication with the exterior and is not limited to communication protocol.

In the present embodiment, the first communication module CM1 includes a communication device capable of directly communicating with nearby devices, and illustratively supports Wi-Fi. The Wi-Fi module of the present embodiment may include an Access Point (AP) function, and a user may easily and quickly access the built-in cam through, for example, a smartphone.

Due to Wi-Fi, the user can easily and quickly access the built-in cam through, for example, a smartphone.

The microphone MC supports voice recording. When the driving images of the vehicle HV is recorded, not only the images are recorded but also the voices are recorded as well.

The impact sensor IS senses an external impact and may be a one-axis or a three-axis acceleration sensor.

The impact sensor IS may be prepared as the built-in cam system BCS, but it is evident that it may be used as an acceleration sensor installed in the host vehicle HV.

The signals of the impact sensor IS may be a starting points for a later described event recording, and the degree of impact serving as a references thereof can be set by the user.

For example, the user may select an impact detection sensitivity that is a criterion for recording an event when setting the built-in cam system BCS through a display screen (i.e., a later described AVN screen) in the vehicle HV.

For example, the impact sensitivity may be classified into five levels: the first level (highly unresponsive), the second level (unresponsive), the third level (normal sensitivity), the fourth level (sensitive), and the fifth level (highly sensitive).

The built-in cam system BCS receives power from a battery (e.g., a 12V battery) installed in the vehicle HV.

Although the system is operated by receiving power of the vehicle HV battery during parking as well as during driving, there may be an over-discharge problem of the vehicle HV battery, and thus, the present embodiment includes the power auxiliary battery BT.

In the present embodiment, the built-in cam system BCS receives power from any one of the battery of the vehicle HV, of the alternator in the case of the internal combustion engine vehicle, and of the lower DC/DC converter in the case of the electric vehicle, while receiving power from the power auxiliary battery BT during parking. However, it is not limited thereto.

The power auxiliary battery BT is charged and discharged depending on an operating environment of the vehicle HV and supplies optimal power for recording and OTA software update during parking

The charging of the power auxiliary battery BT is performed by a vehicle HV battery (a low voltage battery or a high voltage battery of an electric vehicle), or performed by an alternator in the case of an internal combustion engine vehicle HV.

The built-in cam controller BCC is an upper level controller that controls other components of the built-in cam system BCS, and exchanges signals with the controller (VC) of the host vehicle HV and/or the second communication module (vehicle communication module), the sensor module SM, the component controllers APCs, the audio video navigation telematics (AVNT), etc. For example, local interconnect network LIN or controller area network CAN communication may be used for such signal exchange.

Here, the sensor module SM includes one or more of a speed sensor, of an acceleration sensor, of a vehicle position sensor (e.g., a GPS receiver), of a steering angle sensor, of a yaw rate sensor, of a pitch sensor, and of a roll sensor, and the component controllers APCs may include one or more of a turn signal controller, of a turn signal controller, of a wiper controller, of an ADAS system controller, and of an airbag controller.

The built-in cam controller (BCC) controls other components to perform constant recording while driving, constant recording while parking, event recording for recording according to the impact signal of the impact sensor, etc.

When recording, driving information of the vehicle HV is recorded as well.

Here, the vehicle (HV) driving information includes time, vehicle speed, gear position, turn signal information, impact detection sensitivity (one corresponding to the above-described five levels), global positioning system GPS position information, etc.

The vehicle driving information may be received from the vehicle controller VC, but it is that it may also be directly received from a corresponding module or component of the vehicle HV. For example, a vehicle speed may be directly received from a speed sensor of the vehicle HV, a turn signal information (or turn signal information from a turn signal controller) may be directly received from a turn signal controller, or a GPS location information may be received from a AVNT or a GPS receiver.

As described above, the event recording is performed when the event occurrence is detected while parking depending on the impact detection sensitivity set by the user.

In the event recording, recording is performed from a set time before the event occurrence time to a set time after the event occurrence time, and the set time may be selected by the user.

The AVNT is connected to the built-in cam controller BCC through the vehicle controller VC or directly, and the AVNT screen functions as a user interface for receiving various set parameters of the built-in cam system BCS from the user.

The built-in cam controller BCC transmits recorded content to an external server according to a set period, a user selection, or an event (e.g., a degree of impact detection) from a user setting.

The built-in cam controller BCC includes a memory M2 and a processor MP to perform its functions.

In an embodiment, the processor MP may include a semiconductor integrated circuit and/or electronic devices that perform at least one or more of comparison, determination, calculation, and determination to achieve a programmed function. For example, the processor MP may be a computer, a microprocessor MC, a CPU, an ASIC, and electronic circuits (circuitry, logic circuits), or a combination thereof.

The memory M2 may be any type of storage device that stores data that can be read by a computer system, and may include, for example, at least one of a flash memory type, a hard disk type, a micro type, a card type (e.g., a secure digital (SD) card or an eXtream digital (XD) card), etc., and at least a memory type of a Random Access Memory (RAM), of a Static RAM (SRAM), of a Read-Only Memory (ROM), of a Programmable ROM (PROM), of an Electrically Erasable PROM (EEPROM), of a Magnetic RAM (MRAM), of a magnetic disk, and of an optical disk.

Operating software of the BCC is stored in the memory M2, and the processor MP reads and executes the corresponding software to perform the function of the BCC.

In addition, the built-in cam controller BCC includes a buffer memory BM for determination, calculation, and the like in the processor MP.

In addition, the built-in cam controller BCC may include a supercapacitor SC. The supercapacitor SC is charged when power is applied to the built-in cam controller BCC.

When power is suddenly cut off due to impact, damage, or the like, power charged in the supercapacitor SC is used to complete video storage that is in progress.

For example, the super capacitor SC may have a charging capacity capable of maintaining the power of the built-in cam controller BCC for several to tens of seconds.

Meanwhile, the vehicle of the present embodiment may include a preview electrically controlled suspension (P-ECS).

The P-ECS controls the suspension in response to an extreme driving situation such as a speed bump or a pothole, which greatly damages the ride comfort or impacts the vehicle body. Based on the road surface information and navigation map information recognized by the front camera, the damping force of the suspension is adjusted to control the movement of the vehicle body.

In this embodiment, the preview electronic control suspension P-ECS may transmit speed bump information to the built-in cam controller BCC.

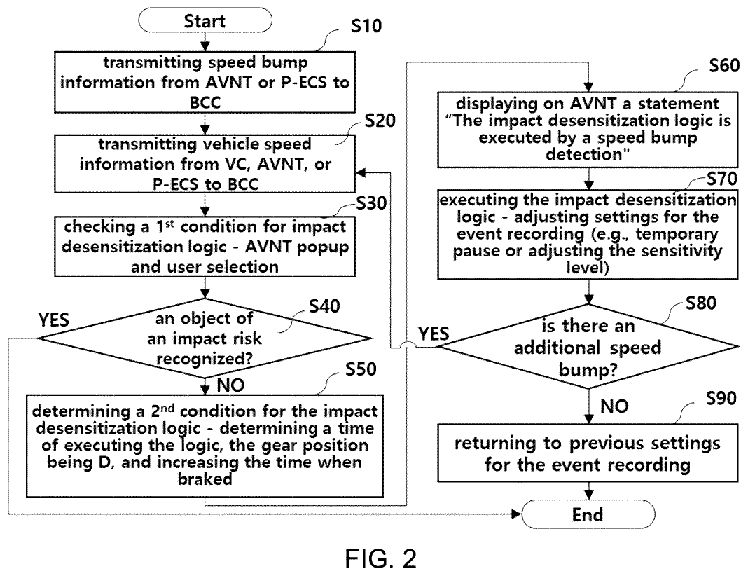

Hereinafter, a process of controlling the built-in cam through the processor MP will be described in detail with reference to FIG. 2.

First, in S10, the built-in cam controller BCC receives speed bump information.

The speed bump information may be received from the AVNT or the P-ECS.

Here, in addition to the speed bump, information on the pothole may also be received from the P-ECS to the BCC.

Further, in S20, the BCC controller receives the vehicle speed information.

The vehicle speed may be received from at least one of the vehicle controller VC, the AVNT, and the P-ECS.

Next, in S30, the processor MP checks the first condition for the impact desensitization logic.

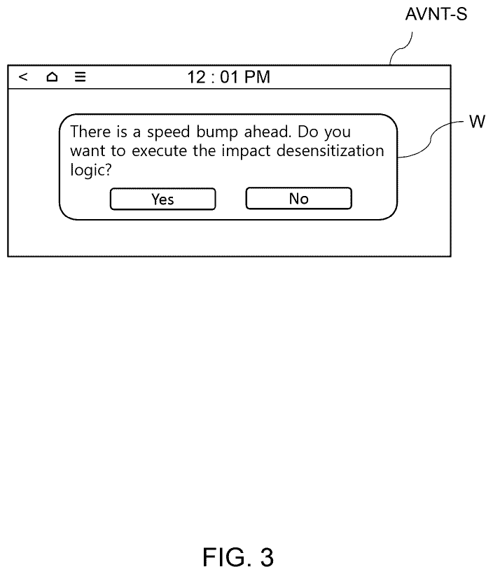

To this end, the processor MP may pop up a user selection window W whether to execute the impact desensitization logic through the AVNT screen AVNT-S. For example, as shown in FIG. 3, the processor MP may pop up a user approval window W on whether to execute the impact desensitization logic through the AVNT screen AVNT-S.

In FIG. 3, a user may input a selection of whether to execute the impact desensitization logic by selecting a “Yes” or “No” button.

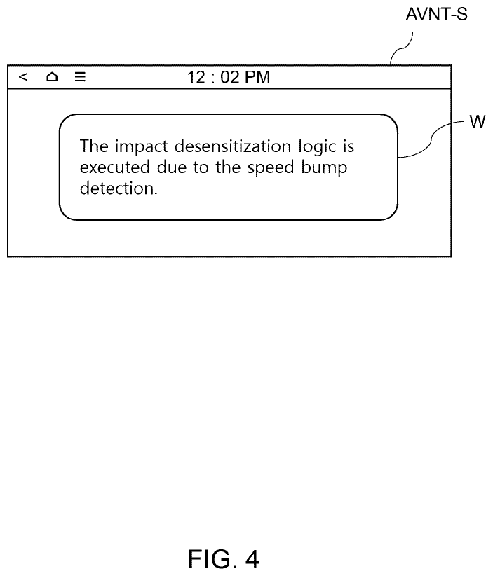

When the execution of the impact desensitization logic is selected in operation S30, notification information indicating that the impact desensitization logic is executed is output through the AVNT screen AVNT-S as shown in FIG. 4, and operation S40 is performed, but otherwise, operation “end” is performed.

In S40, the processor MP receives the surrounding object recognition information from the ADAS sensor or the controller.

Here, the ADAS, for example, may be an Autonomous Emergency Braking (AEB), a Forward Collision-Avoidance Assist (FCA), a Rear Cross-traffic Collision-avoidance Warning (RCCW), a Rear Cross-Traffic Collision-Avoidance Assist (RCCA), or a Blind-Spot Collision Warning (BCW).

In addition, the ADAS sensor is a sensor mounted on a vehicle to perform the ADAS function, and may include at least one of a camera, an ultrasonic wave, a radar, and a LiDAR.

In S40, when an object with a risk of collision around the vehicle is recognized through the ADAS sensor or the controller, the process proceeds to “end” without executing the impact desensitization logic.

When it is determined in operation S40 that there is no object with the risk of collision, in S50, a time of impact desensitization is determined to execute the impact desensitization logic, and whether a transmission gear position is “D (Drive)” is determined. The time of the impact desensitization may be determined using the position of the speed bump, the current position of the vehicle, and the vehicle speed.

In addition, when the brake is operated, the time of the impact desensitization may be adjusted accordingly. For example, when the brake is operated, deceleration according to the operation may be sensed or calculated, and the deceleration may be added at an initial time by a delay of a reaching time by the deceleration from a current position of the vehicle to a position of the speed bump.

In S50, when the transmission gear position is not on “D (Drive)”, the process may proceed to “end”.

In S50, when the transmission gear position is located at “D (Drive)” and the time of impact desensitization is determined, the process proceeds to S60.

In S60, the processor MP may pop up the window W through the AVNT screen AVNT-S to notify that the impact desensitization logic is executed.

Next, in S70, the processor MP executes the impact desensitization logic according to the above mentioned time desensitization.

To this end, the processor MP, for example, may forcibly adjust the setting of event-based recording.

For instance, the processor MP may switch event-based recording to stop.

Alternatively, the processor MP may adjust the sensitivity level of event-based recording. For example, the processor MP may adjust the impact detection sensitivity to a set level of 1 (highly unresponsive), 2 (unresponsive), 3 (normal), 4 (sensitive), and 5 (very sensitive).f (levels correct)

For example, the sensitivity level may be adjusted by adjusting the currently set level down by one level or the set number of levels, or may be adjusted to a specific level (i.e., a first level or a second level) regardless of the current level.

Next, in S80, it is determined whether there are further speed bumps.

When the information on the plurality of speed bumps is received as in S10 (S80 YES), after the impact desensitization logic for the priority speed bump is executed (S70), the process proceeds to S20, and the impact desensitization logic for the subsequent speed bump is sequentially and repeatedly executed.

In the case of the single speed bump (NO in S80), the setting of the event storing adjusted in S70 is returned to the original state (S90).

While the present disclosure has been particularly shown and described with reference to exemplary embodiments thereof, these embodiments are only proposed for illustrative purposes, and do not restrict the present disclosure, and it will be apparent to those skilled in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

What is claimed is:

1. A method for controlling a drive video record system comprising a camera module configured to monitor surroundings of a vehicle, a first memory configured to store a video transmitted from the camera module, and a controller comprising a second memory configured to store a computer program for controlling storage of the video and a processor configured to execute the computer program, the control method including:
receiving, by the processor executing the computer program, information related to a speed bump; and
executing, by the controller, an impact desensitization logic based on the information.

2. The method according to claim 1, wherein executing the impact desensitization logic includes receiving a selection for executing the impact desensitization logic from a user.

3. The method according to claim 2, wherein receiving the selection includes generating a pop up window through which the selection is input on an audio video navigation telematics (AVNT) screen according to the information, and wherein executing the impact desensitization logic includes notifying through the AVNT screen that the impact desensitization logic will be executed.

4. The method according to claim 1, wherein executing the impact desensitization logic includes determining whether to execute the impact desensitization logic according to object recognition information received from a sensor or a controller of an advanced driving assistance system (ADAS).

5. The method according to claim 1, wherein executing the impact desensitization logic includes at least one of determining a time of initiating the impact desensitization logic or determining whether a transmission gear position is in a drive position.

6. The method according to claim 5, wherein determining the time includes adjusting the time according to a brake operation.

7. The method according to claim 1, wherein executing the impact desensitization logic includes adjusting a setting for an event-based recording.

8. The method according to claim 7, wherein adjusting the setting for the event-based recording includes at least one of deactivating the event-based recording or adjusting an impact sensitivity level of the event-based recording.

9. The method according to claim 1, wherein receiving the information includes receiving information related to a plurality of successive speed bumps, and executing the impact desensitization logic includes executing the impact desensitization logic sequentially and repeatedly for the plurality of successive speed bumps.

10. The of claim 1, wherein receiving the information includes receiving the information from the AVNT or a preview electrically controlled suspension (Preview-ECS).

11. A drive video record system for a vehicle, the drive video record system comprising:
a camera module configured to monitor surroundings of the vehicle;
a first memory configured to store a video transmitted from the camera module; and
a controller comprising a second memory configured to store a computer program for controlling storage of the video, and a processor configured to execute the computer program,
wherein the controller is configured to receive information related speed bump and executes an impact desensitization logic based on the information by the processor executing the computer program.

12. The drive video record system of claim 11, wherein the controller is further configured to receive a selection for executing the impact desensitization logic from a user.

13. The drive video record system of claim 12, wherein the controller is further configured to generate a pop up window through which the selection is input on an audio video navigation telematics (AVNT) screen according to the information and notify through the AVNT screen that the impact desensitization logic will be executed.

14. The drive video record system of claim 11, wherein the controller is further configured to determine whether to execute the impact desensitization logic according to object recognition information received from a sensor or a controller of an advanced driving assistance system (ADAS).

15. The drive video record system of claim 11, wherein the controller is further configured to perform at least one of determining a time of initiating the impact desensitization logic or determining whether a transmission gear position is positioned in a drive position.

16. The drive video record system of claim 11, wherein the controller is further configured to adjust a setting for an event-based recording.

17. The drive video record system of claim 16, wherein the controller is further configured to perform at least one of deactivating an event-based recording and adjusting an impact sensitivity level of the event-based recording.

18. The drive video record system of claim 11, wherein the controller is further configured to receive information related to a plurality of successive speed bumps, and wherein the controller is further configured to execute the impact desensitization logic sequentially and repeatedly for the plurality of speed bumps.

19. The drive video record system of claim 11, wherein the controller is further configured to receive the information from the AVNT or a preview electrically controlled suspension (Preview-ECS).

20. A vehicle comprising the drive video record system of claim 11.
